(19) United States
(12) Patent Application Publication
(10) Pub. No.: US 2024/0373488 A1
(43) Pub. Date: Nov. 7, 2024

(54) NETWORK-CONTROLLABLE REPEATER MANAGEMENT

(71) Applicant: ZTE CORPORATION, Shenzhen (CN)

(72) Inventors: Wei CAO, Shenzhen (CN); Nan ZHANG, Shenzhen (CN); Ziyang LI, Shenzhen (CN); Jianwu DOU, Shenzhen (CN); Shuang ZHENG, Shenzhen (CN)

(73) Assignee: ZTE CORPORATION, Shenzhen (CN)

(21) Appl. No.: 18/775,623

(22) Filed: Jul. 17, 2024

Related U.S. Application Data
(63) Continuation of application No. PCT/CN2022/086021, filed on Apr. 11, 2022.

(51) Int. Cl. H04W 76/15; H04L 43/0817; H04W 8/22; H04W 52/36

(52) U.S. Cl. CPC H04W 76/15; H04L 43/0817; H04W 8/22; H04W 52/367

(57) ABSTRACT

The present disclosure is directed to network-controllable repeater management, including establishing a first communication link between a first network node and a second network node, communicating, by the second network node with the first network node via the first communication link, and communicating, by the second network node with a third network node via a second communication link.

### CROSS REFERENCE TO RELATED APPLICATIONS

The present application is a continuation of International Patent Application No. PCT/CN2022/086021 filed on Apr. 11, 2022, the contents of which are incorporated herein by reference in its entirety.

### TECHNICAL FIELD

The disclosure relates generally to wireless communications and, more particularly, to systems, methods, and non-transitory computer-readable media for network-controllable repeater management.

### BACKGROUND

As new radio (NR) systems move to higher frequencies (around 4 GHz for FR1 and above 24 GHz for FR2), propagation conditions can degrade compared to lower frequencies, exacerbating coverage challenges. As a result, further densification of cells may be necessary. While the deployment of regular full-stack cells is preferred, it may not be always possible (e.g., not availability of backhaul) or economically viable. To provide blanket coverage in cellular network deployments with relatively low cost, RF repeaters with full-duplex amplify-and-forward operation may be used in 2G, 3G and 4G systems. However, RF repeaters amplify both signal and noise and increases interference in the system. The main disadvantage is that they amplify signal and noise and, hence, may contribute to an increase of interference (pollution) in the system. RF repeaters are non-regenerative relay nodes and that simply amplify-and-forward everything that they receive with a full-duplex mode.

### SUMMARY

To cope with unwanted interference, a network controllable repeater (NCR) can use side control information from a base station (BS) to enable an intelligent amplify-and-forward operation. The NCR can be located in a position where it can receive signal from the BS via wireless communication. To facilitate proper amplify-and-forward operation of the NCR, the BS can manage the NCR via control messages.

At least some arrangements are directed to management related messages between a BS and an NCR, and can include message flow and message content. In one aspect, management can include a reset. The NCR can be reset by the BS. For example, the BS finds the NCR does not work properly and resets it. The NCR can restart or reinitialize accordingly. In one aspect, management can include a control link setup. The control link between the NCR and the BS can be setup after the NCR successfully finishes its initial access. In one aspect, management can include a reconfiguration. The BS can reconfigure the NCR if needed, for example, if the BS needs to adjust the NCR's parameters. In one aspect, management can include a status report. The NCR can report its working status to the BS periodically or in a trigger-based manner.

The example arrangements relate to network-controllable repeater management. In some arrangements, a method by an NCR includes establishing a first communication link between a first network node and a second network node, communicating, by the second network node with the first network node via the first communication link, and communicating, by the second network node with a third network node via a second communication link.

In some arrangements, a method by a base station includes establishing a first communication link between a first network node and a second network node, and communicating, by the first network node with the second network node via the first communication link, wherein the second network node communicates with a third network node via a second communication link.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3 is a diagram illustrating network-controllable repeater management, according to various arrangements.

FIG. 4 is a diagram illustrating network-controllable repeater management, according to various arrangements.

FIG. 5 is a signaling diagram illustrating reset signaling in network-controllable repeater management, according to various arrangements.

FIG. 6 is a signaling diagram illustrating first control link signaling in network-controllable repeater management, according to various arrangements.

FIG. 7 is a signaling diagram illustrating second control link signaling in network-controllable repeater management, according to various arrangements.

FIG. 8 is a signaling diagram illustrating reconfiguration signaling in network-controllable repeater management, according to various arrangements.

FIG. 9 is a signaling diagram illustrating status report signaling in network-controllable repeater management, according to various arrangements.

FIG. 10 is a diagram illustrating an example method for status report signaling in network-controllable repeater management, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

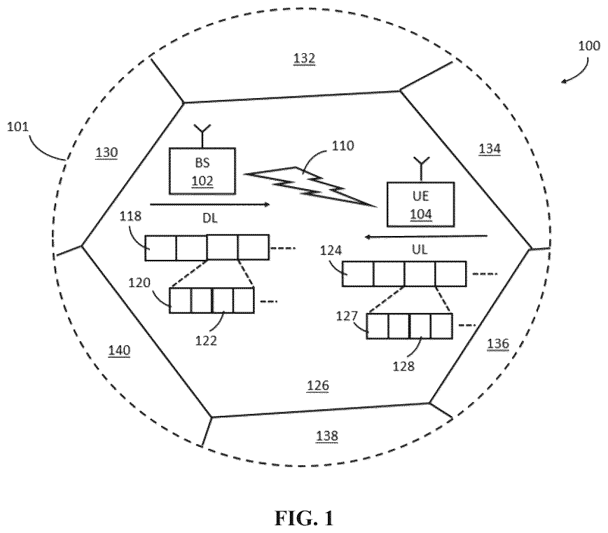

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

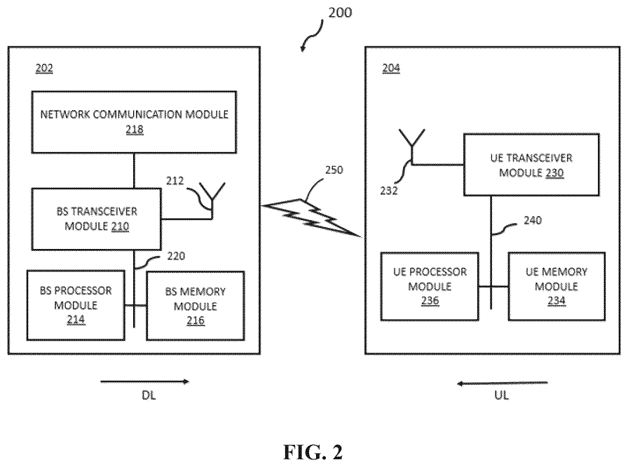

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

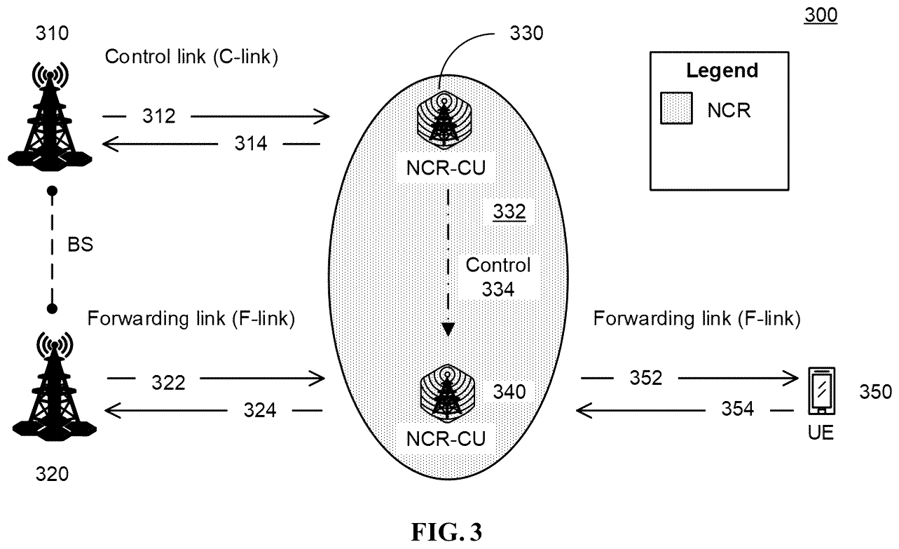

FIG. 3 is a diagram illustrating network-controllable repeater management, according to various arrangements. As illustrated by way of example in FIG. 3, an example system 300 can include a first BS 310 communicating by one or more control links 312 and 314, a second BS 320 communicating by one or more forwarding links 322 and 324, an NCR-CU 330, an NCR 332, control signaling 334, an NCR-FU 340, and a UE 350 associated with one or more forwarding links 352 and 354. The first communication link can include one or more of the control link and the forwarding link between the BS 310/320 and the NCR 332 as shown by way of example in FIG. 3. The control link 312 can communicate downlink data from the first BS 310 to the NCR 332, and the control link 314 can communicate uplink data from the NCR 332 to the first BS 310. The forwarding link 322 can communicate downlink data from the second BS 320 to the NCR 332, and the forwarding link 324 can communicate uplink data from the NCR 332 to the second BS 320. The forwarding link 352 can communicate downlink data from the NCR 332 to the UE 350, and the forwarding link 324 can communicate uplink data from the UE 350 to the NCR 332. For example, the first communication link includes either or both of the C-link 312/314 between the BS 310 and the NCR-CU 330 or the F-link 322/324 between the BS 320 and the NCR-FU 340. The second communication link can include one or more of the forwarding links 352 and 354 between the UE 350 and the NCR 332. For example, the second communication link includes either or both of the F-link 352/354 between the UE 350 and the NCR 332.

The NCR can be located in a position where it can receive signal from the BS via wireless communication. The NCR can have a control unit (CU) and a forwarding unit (FU). The CU can support part of UE function. The FU can include a radio unit or a RIS. When the NCR is working, the CU can communicate with the BS to exchange control signaling. The CU can control the amplify-and-forward operation of the FU using the side control information from the BS.

The control link between the BS and the NCR-CU can be defined for NCR management, which may include various functions. Various functions can include a reset. The NCR can be reset by the BS. For example, the BS finds the NCR does not work properly and resets it. The NCR can restart or reinitialize accordingly. Various functions can include a control link setup. The control link between the NCR and the BS can be setup after the NCR successfully finishes its initial access. Various functions can include a reconfiguration. The BS can reconfigure the NCR if needed, for example, if the BS needs to adjust the NCR's parameters. Various functions can include a status report. The NCR can report its working status to the BS periodically or in a trigger-based manner.

FIG. 4 is a diagram illustrating network-controllable repeater management, according to various arrangements. At least one of the example systems 100, 200 and 300 can perform network-controllable repeater management in accordance with diagram 400. As one example, NCR management 410 can include one or more of reset 420, control link setup 430, reconfiguration 440, and status report 450. The reset 420 can include operation for a first reset case (case 0) and a second reset case (case 1). The first reset case can be applied to a single NCR. The second reset case can be applied to a plurality of NCRs. The control link setup 430 can include operation for a first control link setup case (case 2) and a second control link setup case (case 3). The first control link setup case can be applied after NCR identification and authentication. The second control link setup case can be applied concurrently or simultaneously with NCR identification and authentication. The reconfiguration 440 can include a reconfiguration case (case 4). The reconfiguration case can be applied using a reconfigurable parameters list. The status report 450 can include operation for a first status report case (case 5), a second status report case (case 6), and a third status report case (case 7). The first status report case can be applied based on a self-triggered condition, state, threshold, or the like. The second status report case can be applied based on a period-triggered condition, state, threshold, or the like. The period can correspond to an predetermined period discussed herein. The third status report case can be applied in response to an ACK for side control information.

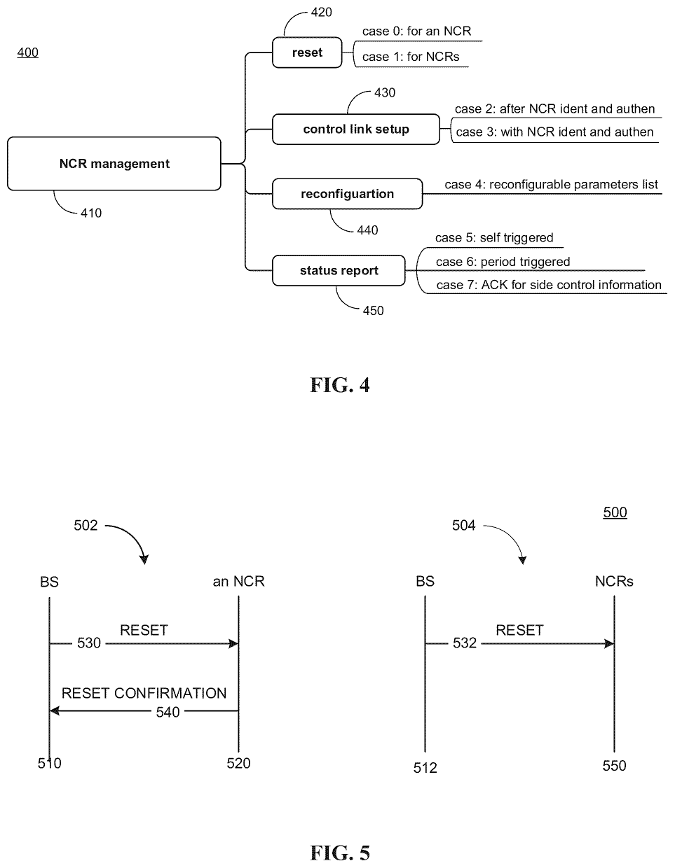

FIG. 5 is a signaling diagram illustrating reset signaling in network-controllable repeater management, according to various arrangements. As illustrated by way of example in FIG. 5, an example signaling diagram 500 can include BS 510 and 512, NCR 520, reset signaling 530 and 532, reset confirmation signaling 540, and one or more NCRs 550.

The BS can use RESET to restart or reinitialize the NCR. For example, if the BS finds the NCR does not work properly, or the configuration of the BS is changed and the attached NCRs are impacted, the BS can send RESET message to at least one NCR. The NCR can restart and/or reinitialize accordingly. As one example, with respect to the instance in which the configuration of the BS is changed and the attached NCRs are impacted, the BS changes its DL common signals, and the NCRs are reset to reinitialize the connection to the BS. In this example, the BS can change its DL common signals by changing the number of SSBs to adjust its coverage.

If an identifier of the NCR is included in the RESET message, the NCR can reply with a RESET CONFIRMATION, can stop its ongoing amplify-and-forward operation, and can restart and/or reinitialize accordingly. In this case, the RESET message can be carried by NCR-specific signaling to the given NCR and the NCR's identifier is implicitly included, e.g., scrambled with the NCR's RNTI.

The RESET message can be carried by a common signaling with an explicit NCR identifier. For example, if the BS needs to RESET multiple NCRs, the identifiers of those NCRs can be listed in a common signaling to save both signaling overhead and control delay. The attached NCRs can receive the common signaling and check whether their corresponding identifiers are included in the list. The NCRs in the list can stop their ongoing amplify-and-forward operation and restart or reinitialize accordingly. To save signaling cost, the RESET CONFIRMATION is not needed. If the RESET message includes a cell identifier (e.g., PCI) or a beam identifier (e.g., DL RS index like an SSB index), the message can apply to all the NCRs in the specific cell or beam. In this case, the RESET message can be carried by cell-specific signaling or beam-specific signaling to the NCRs in the corresponding cell or beam coverage. All NCRs can stop their ongoing amplify-and-forward operation and restart or reinitialize accordingly. No RESET CONFIRMATION is needed.

The NCR-CU can use CONTROL LINK SETUP to setup the control link with its serving BS. The control link setup can be carried out after the integration of the NCR or together with the integration of the NCR. The integration procedure can include the identification and authentication of the NCR. The identification and authentication of the NCR can be carried out by RAN (simplified) or by CN (legacy). Since the NCR can forward data between the BS and the UEs without processing, there is no security issue involved. In addition, the NCR has no impact on other CN functions such as QoS management and PCF. Therefore, a RAN-based NCR identification and authentication procedure is advantageous. The control link setup can be carried out after the integration of the NCR. The control ink setup can be carried out together with the integration of the NCR. The situation in which the control link setup can be carried out after the integration of the NCR can be prioritized, due to less impact to CN.

If the control link setup is carried out after the integration of the NCR, the content of the control link setup message may include. various aspects. One aspect can include a capability of the NCR, that can be mandatory, and can indicate parameters to be used by the BS in following control procedure. One aspect can include a maximum beam number for the control link (i.e., between BS and NCR) and for the forwarding link (i.e., between NCR and UE). One aspect can include a supported frequency band for the control link (i.e., between BS and NCR) and for the forwarding link (i.e., between NCR and UE). One aspect can include a supported UL control and forwarding multiplexing manner, i.e., TDM and/or FDM. One aspect can include a maximum transmission power for the control link (i.e., between BS and NCR) and for the forwarding link (i.e., between NCR and UE). One aspect can include a location of the NCR that can be Optional, and can be omitted if available at the BS via OAM configuration.

If the BS accepts the setup, a CONTROL LINK SETUP RESPONSE is sent by the BS to the NCR, which may include content indicating a configuration of the NCR. Content can include a beam number for the control link (i.e., between BS and NCR) and for the forwarding link (i.e., between NCR and UE). The value can be not more than the maximum beam number. Content can include a frequency band for the control link (i.e., between BS and NCR) and for the forwarding link (i.e., between NCR and UE). The band can be included in the supported frequency band. Content can include transmission power for the control link (i.e., between BS and NCR) and for the forwarding link (i.e., between NCR and UE). The value can be not more than the maximum transmission power. Content can include an amplification gain for the control link (i.e., between BS and NCR) and for the forwarding link (i.e., between NCR and UE). The value can be a semi-fixed value for forwarding power boosting. Content can include a status report trigger method for the NCR to report its working status. The status report trigger method can be event-based and/or period-based. Content can include a status report period for the NCR to report its working status periodically. This parameter can be applicable if a periodic status report is adopted. If the BS rejects the setup, a CONTROL LINK SETUP FAILURE can be sent by the BS to the NCR. The NCR can then release its connection with the BS accordingly.

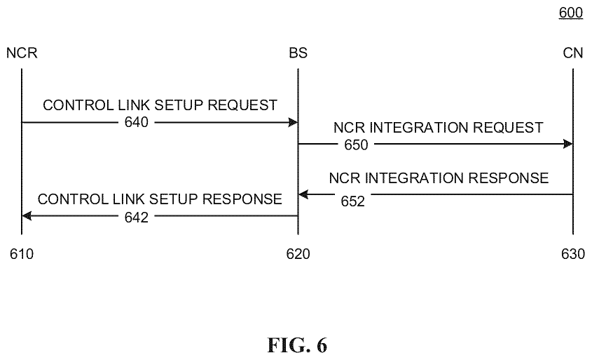

FIG. 6 is a signaling diagram illustrating first control link signaling in network-controllable repeater management, according to various arrangements. As illustrated by way of example in FIG. 6, an example signaling diagram 600 can include NCR 610, BS 620, CN 630, control link setup request signaling 640, control link setup response signaling 642, NCR integration request signaling 650, and NCR integration response signaling 652.

If the control link setup is carried out together with the integration of the NCR, the content of the CONTROL LINK SETUP message may include one or more various aspects. One aspect can include an identifier of the NCR that can be mandatory, and can indicate a readable name for CN to identify and authenticate the NCR. One aspect can include a capability of the NCR, that can be mandatory and can indicate parameters to be used by the BS in following control procedure. One aspect can include a maximum beam number for the control link (i.e., between BS and NCR) and for the forwarding link (i.e., between NCR and UE). One aspect can include a supported frequency band, for the control link (i.e., between BS and NCR) and for the forwarding link (i.e., between NCR and UE). One aspect can include a supported UL control and forwarding multiplexing manner, i.e., TDM and/or FDM. One aspect can include a maximum transmission power for the control link (i.e., between BS and NCR) and for the forwarding link (i.e., between NCR and UE). One aspect can include a location of the NCR, and can be omitted if available at the BS via OAM configuration.

The BS can forward the identifier of the NCR to the CN for identification and authentication. If the CN accepts the integration of the NCR and the BS accepts the control link setup, a CONTROL LINK SETUP RESPONSE can be sent by the BS to the NCR, which may include content as the NCR's configuration. Content can include a beam number for the control link (i.e., between BS and NCR) and for the forwarding link (i.e., between NCR and UE). The value can be not more than the maximum beam number. Content can include a frequency band for the control link (i.e., between BS and NCR) and for the forwarding link (i.e., between NCR and UE). The band can be included in the supported frequency band. Content can include a transmission power for the control link (i.e., between BS and NCR) and for the forwarding link (i.e., between NCR and UE). The value can be not more than the maximum transmission power. Content can include an amplification gain, for the control link (i.e., between BS and NCR) and for the forwarding link (i.e., between NCR and UE). The value can be a semi-fixed value for forwarding power boosting. Content can include a status report trigger method for the NCR to report its working status. The status report trigger method can be event-based or period-based. Content can include a status report period for the NCR to report its working status periodically. This parameter is applicable if periodic status report is adopted.

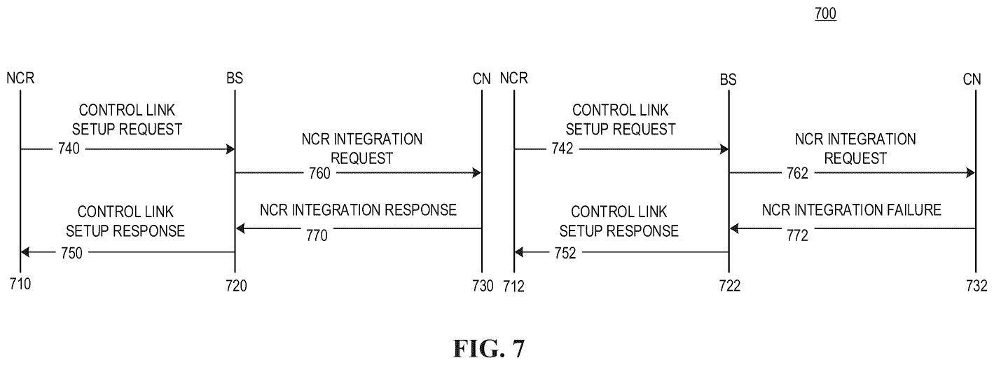

FIG. 7 is a signaling diagram illustrating second control link signaling in network-controllable repeater management, according to various arrangements. As illustrated by way of example in FIG. 7, an example signaling diagram 700 can include NCR 710 and 712, BS 720 and 722, CN 730 and 732, control link setup request signaling 740 and 742, control link setup failure signaling 750 and 752, NCR integration request signaling 760 and 762, and NCR integration response signaling 770 and NCR integration failure signaling 772.

If the CN and/or the BS rejects the control link setup, a CONTROL LINK SETUP FAILURE can be sent by the BS to the NCR. The NCR can then release its connection with the BS accordingly.

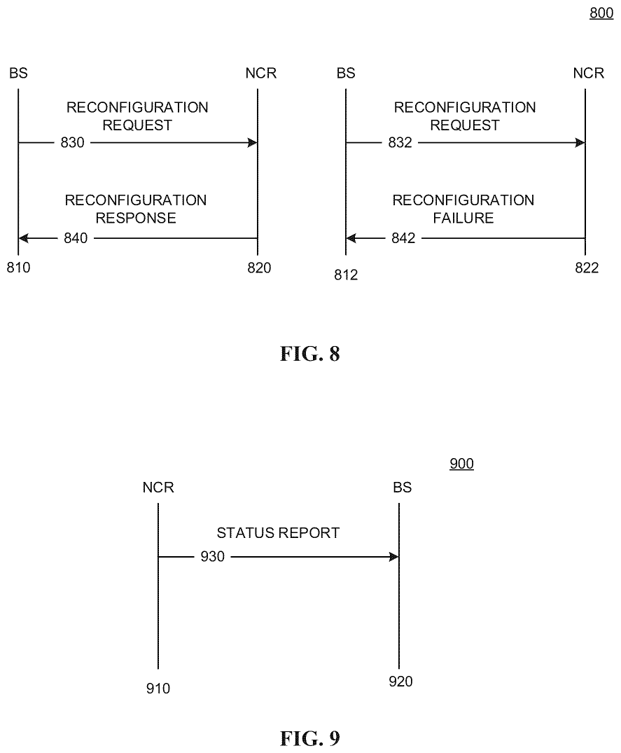

FIG. 8 is a signaling diagram illustrating reconfiguration signaling in network-controllable repeater management, according to various arrangements. As illustrated by way of example in FIG. 8, an example signaling diagram 800 can include BS 810 and 812, NCR 820 and 822, reconfiguration request signaling 830 and 832, and reconfiguration response signaling 840 and reconfiguration failure signaling 842.

The BS uses RECONFIGURATION to reconfigure the control parameters of an attached NCR. The possible configurable parameters can include various parameters. A parameter can include a beam number for the control link (i.e., between BS and NCR) and for the forwarding link (i.e., between NCR and UE). A parameter can include a frequency band for the control link (i.e., between BS and NCR) and for the forwarding link (i.e., between NCR and UE). A parameter can include a transmission power for the control link (i.e., between BS and NCR) and for the forwarding link (i.e., between NCR and UE). A parameter can include an amplification gain for the control link (i.e., between BS and NCR) and for the forwarding link (i.e., between NCR and UE). A parameter can include a status report trigger method for the NCR to report its working status. The status report trigger method can be event-based or period-based. A parameter can include a status report period for the NCR to report its working status periodically. This parameter can be applicable if periodic status report is adopted. If the NCR is successfully reconfigured, a RECONFIGURATION RESPONSE can be sent by the NCR to the BS. If the NCR is not successfully reconfigured, a RECONFIGURATION FAILURE can be sent by the NCR to the BS.

FIG. 9 is a signaling diagram illustrating status report signaling in network-controllable repeater management, according to various arrangements. As illustrated by way of example in FIG. 9, an example signaling diagram 900 can include NCR 910, BS 920, and status report signaling 930. The NCR can use STATUS REPORT to report its working status to the BS. The status report can be NCR self-triggered based on event detection or period-triggered based on one or more of the configuration of the NCR and an ACK associated with side control information.

A malfunction or abnormality report can be NCR self-triggered. As one example, a malfunction or abnormality report can be associated with an RF fault. The NCR-CU can monitor the NCR-RF working status and report to the BS if the NCR-RF does not work in accordance with one or more predetermined aspects, e.g., device malfunction. After reporting the RF fault to the BS, the NCR can stop its amplify-and-forward operation to or from the UE. As one example, a malfunction or abnormality report can be associated with overheating. The NCR-CU can monitor the NCR working status and report to the BS if the NCR does not work in accordance with one or more predetermined aspects, e.g., overheating. After reporting the overheat to the BS, the NCR may stop its amplify-and-forward operation to or from the UE. As one example, a malfunction or abnormality report can be associated with self-excitation. The NCR-CU can monitor the NCR-RF self-excitation and report to the BS according to different levels of criteria preconfigured by the BS. The system can measure self-excitation in view of one or more parameters.

The BS can configure possible parameters to the NCR for self-excitation measurement used by the NCR-RF. A parameter can include a time interval, with possible periodicity. A parameter can include a frequency band, with a possible sweeping pattern. The sweeping pattern can be used by the NCR-RF in its amplify-and-forward operation. A parameter can include a beam index or corresponding spatial setting or RS index. The beam index can be applicable to the link between the NCR and the UEs, i.e., F-link 322/324 and F-link 352/354 in FIG. 3. A parameter can include one or more power related parameters, e.g., transmission power or amplifying factor. A parameter can include a different level of criteria used for the self-excitation level determination.

The NCR-RF can forward the DL signal for a self-excitation measurement using the dedicated resource. Simultaneously, the NCR-CU can conduct the measurement over the dedicated resource. The NCR-CU can report to the BS about the self-excitation measurement result. The NCR-CU can compare the self-excitation measurement result with the preconfigured criteria and determines the self-excitation level. The NCR-CU can report to the BS the measured self-excitation level.

A keep-alive and channel quality report can be period-triggered based on the NCR's configuration. A report can be associated with a heartbeat. The NCR-CU can periodically send a heartbeat report to the BS if the NCR-RF is configured with a status report period. The heartbeat report can be skipped if the NCR is scheduled when the heartbeat report is to be sent. A report can be associated with periodic channel quality. The channel quality between the BS and the NCR should be good enough to ensure forwarding signal quality. The NCR-CU can monitor the channel quality and report to the BS periodically. To save signaling overhead, a predetermined threshold for RSRP/RSRQ of DL RS can be defined. The channel quality report can be reported only when the measured RSRP/RSRQ of DL RS is lower than the predetermined threshold.

The STATUS REPORT RESPONSE from the BS can be optional. For example, with respect to a heartbeat, the STATUS REPORT RESPONSE from the BS can be omitted to save signaling cost. As one example, with respect to RF fault, the STATUS REPORT RESPONSE from the BS can be sent to confirm reception. From the viewpoint of signaling, the STATUS REPORT can be carried by SR. A malfunction or abnormality report can have a higher priority than a keep-alive and channel quality report. Therefore, different SR configurations can be configured to the NCR.

SR configuration for an NCR can include physical layer signaling. As one example, physical layer signaling can include one or more of DCI and UCI. This option is more suitable for the NCR self-triggered status report based on event detection, which can be the most urgent report from the NCR and may not contain extra bits. In addition, the period-triggered status report based on the NCR's configuration can also use this option. For example, the heartbeat report may not contain extra bit and this physical layer signaling based option can be used to reduce signaling delay. If the BS receives a physical layer signaling based SR (e.g., the heartbeat SR), it may not need to allocate UL grant to the NCR for further communication.

The NCR can be configured by SchedulingRequestResourceConfig a set of configurations for SR in a PUCCH transmission using either PUCCH format 0 or PUCCH format 1. A NCR can be configured by a new schedulingRequestIDForRFFaultReport in the PUCCH transmission using either PUCCH format 0 or PUCCH format 1. The priority of this SR ID should be set as high. A NCR can be configured by a new schedulingRequestIDForOverheatReport in the PUCCH transmission using either PUCCH format 0 or PUCCH format 1. The priority of this SR ID should be set as high. A NCR can be configured by a new schedulingRequestIDForHeartbeatReport in the PUCCH transmission using either PUCCH format 0 or PUCCH format 1. The priority of this SR ID can be set as low.

SR configuration for an NCR can be associated with a MAC CE. This option is suitable for the period-triggered status report based on the NCR's configuration, which can include a regular report from the NCR with less urgency. However, the NCR self-triggered status report based on event detection content can also be listed for completeness. A new Status Report MAC CE can be defined for the status report with a new predefined LCID. The priority of the Status Report MAC CE can be set as high. The NCR can be configured by SchedulingRequestResourceConfig a set of configurations for SR in a PUCCH transmission using either PUCCH format 0 or PUCCH format 1, which can include a new schedulingRequestIDForStatusReport corresponding to the newly predefined LCID for the Status Report MAC CE. After reception of the status report SR from the NCR, the BS can indicate an UL grant to the NCR. The NCR can reply with the Status Report MAC CE. The Status Report MAC CE can include one or more reports associated with RF fault, overheating, heartbeat, and periodic channel quality.

As one example, ACK for side control information can be carried by the STATUS REPORT. For example, the side control information may be sent by the BS to the NCRs via DCI, which may include various content. As one example, content can include one or more of timing, a TDD UL-DL configuration, a beam, an on/off state, and power control.

In NR, a UE does not reply ACK/NACK to the BS when it receives DCI from the BS. For NCR, however, the side control information via DCI uses ACK/NACK to inform the BS that the NCR has received the side control information. Present implementations can perform accordingly, as discussed below.

The BS can send to the NCR an indication that the NCR needs to reply an ACK/NACK for its received side control information carried by DCI. If the BS does not send the indication to the NCR, the NCR does not reply ACK/NACK for its received side control information carried by DCI. The indication can include multiple types of indications.

A first type of indication can correspond to an indication that the NCR needs to reply ACK for each received side control information carried by DCI. In this case, the NCR can use current PUCCH mechanism to carry the ACK. The ACK can be carried by one or more resources. As one example, the ACK can be carried by the semi-static UCI resource (e.g., preconfigured semi-static PUCCH resource similar to periodic SR or SPS PDSCH HARQ-ACK) following the received side control information. As another example, the ACK can be carried by the PDCCH scheduled HARQ-ACK resource (e.g., a preconfigured PUCCH resource set and a selected PUCCH resource from the preconfigured PUCCH resource set).

A second type of indication can correspond to an indication that the NCR needs to reply ACK for multiple received side control information carried by DCI. In this case, the NCR can include the ACK for multiple received side control information carried by DCI into a STATUS REPORT message. The NCR can be configured by the BS with a number of side control information messages to be acknowledged together. The NCR can send a STATUS REPORT message including the multiple ACK after receiving the number of side control information messages to the BS. The NCR can be configured by the BS with a periodic UL grant for STATUS REPORT including the multiple ACK for received side control information. The NCR can send a STATUS REPORT message including the multiple ACK with the periodic UL grant if it receives side control information messages during the period.

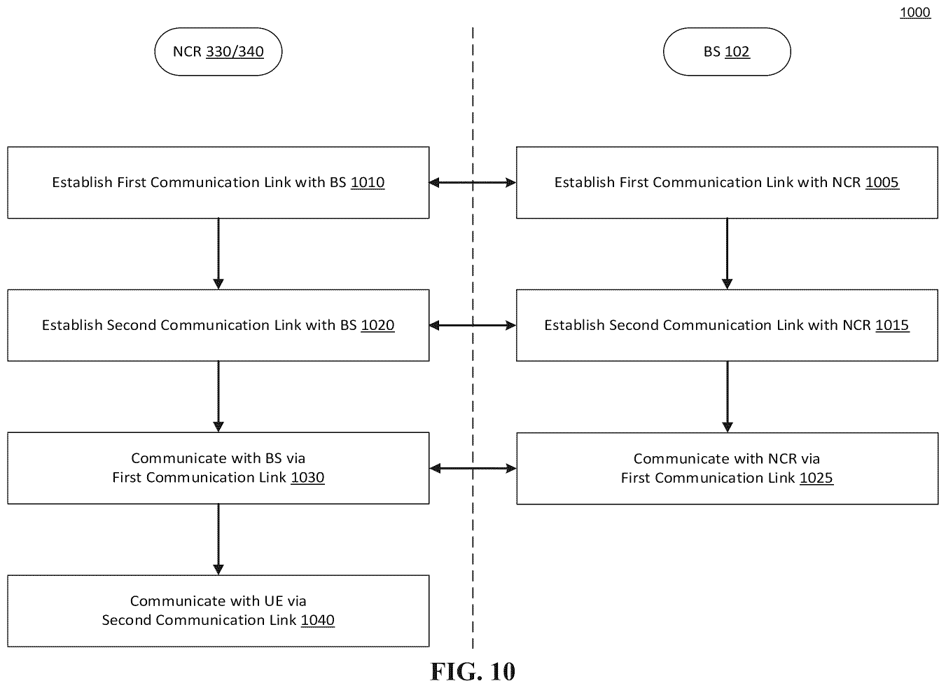

FIG. 10 is a diagram illustrating an example method for status report signaling in network-controllable repeater management, according to various arrangements. Referring to FIGS. 1-9, the method 1000 can be performed by the NCR 330 or 340 and the BS 102.

At 1010, the method can establish, by an NCR, a first communication link with a BS. The method 1000 can then continue to 1020. At 1005, the method can establish, by a BS, a first communication link with an NCR. The method 1000 can then continue to 1015. At 1020, the method can establish, by an NCR, a second communication link with a BS. The method 1000 can then continue to 1030. At 1015, the method can establish, by a BS, a second communication link with an NCR. The method 1000 can then continue to 1025. At 1030, the method can communicate from an NCR with a BS via the first communication link. The method 1000 can then continue to 1040. At 1025, the method can communicate from a BS with an NCR via the first communication link. The method 1000 can then continue to 1040. The method 1000 can end at 1025. At 1040, the method can communicate, from an NCR, with a UE via the second communication link. The method 1000 can end at 1040.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

What is claimed is:

1. A wireless communication method, comprising:
establishing a first communication link between a first network node and a second network node;
communicating, by the second network node, with the first network node via the first communication link; and
communicating, by the second network node, with a third network node via a second communication link.

2. The wireless communication method of claim 1, wherein
the first network node comprises a base station;
the second network node comprises a Network Controllable Repeater (NCR); and
the third network node comprises a wireless communication device.

3. The wireless communication method of claim 1, wherein the establishing the first communication link comprises restarting the second network node by resetting the second network node by the first network node in response to determining that the second network node is malfunctioning or in response to determining that configurations of the first network node related to functioning of the second network node have changed.

4. The wireless communication method of claim 3, wherein the resetting the second network node by the first network node comprises:
receiving, by the second network node from the first network node, a reset message, wherein the reset message comprises an identifier of the second network node;
sending, by the second network node to the first network node, a reset confirmation message in response to receiving the reset message;
stopping the communicating with the third network node via the second communication link; and
restarting the second network node.

5. The wireless communication method of claim 4, wherein
the reset message is received by the second network node from the first network node via a signaling specific to the second network node; and
the identifier of the second network node is implicitly included in the reset message as scrambled by a Radio Network Temporary Identifier (RNTI) of the second network node.

6. The wireless communication method of claim 3, wherein the resetting the second network node by the first network node comprises:
receiving, by the second network node from the first network node, a reset message carried by a common signaling received by a plurality of network nodes, wherein the reset message comprises a list of identifiers of the plurality of network nodes;
determining, by the second network node, that the list of identifiers includes an identifier of the second network node;
stopping the communicating with the third network node via the second communication link; and
restarting the second network node.

7. The wireless communication method of claim 3, wherein the resetting the second network node by the first network node comprises:
receiving, by the second network node from the first network node, a reset message that comprises one of the following:
a cell identifier identifying a cell associated with the second network node, the reset message is carried on cell-specific signaling; or
a beam identifier identifying a beam associated with the second network node, wherein the reset message is carried on beam-specific signaling;
stopping the communicating with the third network node via the second communication link; and
restarting the second network node.

8. The wireless communication method of claim 1, wherein the establishing the first communication link comprises one of the following:
sending, by the second network node to the first network node, a control link setup request after the second network node is integrated with the first network node, wherein the control link setup request indicates capabilities of the second network node; or
sending, by the second network node to the first network node, a control link setup request while the second network node is being integrated with the first network node, wherein the control link setup request indicates an identifier of the second network node and capabilities of the second network node, wherein the identifier of the second network node is used for identification and authentication for integrating the second network node with the first network node.

9. The wireless communication method of claim 8, wherein the capabilities of the second network node comprises a maximum number of beams for the first communication link, a maximum number of beams for the second communication link, a supported frequency band for the first communication link, a supported frequency band for the second communication link, a supported uplink control and forwarding multiplexing method, a maximum transmission power for the first communication link, or a maximum transmission power for the second communication link.

10. The wireless communication method of claim 8, further comprising receiving, by the second network node from the first network node, a control link setup response in response to the first network node accepting the control link setup request, wherein the control link setup response comprises at least one of a number of beams for the first communication link, a number of beams for the second communication link, a frequency band for the first communication link, a frequency band for the second communication link, a transmission power for the first communication link, a transmission power for the second communication link, an amplification gain for the first communication link, an amplification gain for the second communication link, a status report trigger method for triggering a status report by the second network node, or a status report period for the status report by the second network node.

11. The wireless communication method of claim 1, wherein the establishing the first communication link comprises:
receiving, by the second network node from the first network node, a reconfiguration request for at least one control parameter; and
reconfiguring, by the second network node, the at least one control parameter based on the reconfiguration request.

12. The wireless communication method of claim 11, wherein the at least one control parameter comprises at least one of a number of beams for the first communication link, a number of beams for the second communication link, a frequency band for the first communication link, a frequency band for the second communication link, a transmission power for the first communication link, a transmission power for the second communication link, an amplification gain for the first communication link, an amplification gain for the second communication link, a status report trigger method for triggering a status report by the second network node, or a status report period for the status report by the second network node.

13. The wireless communication method of claim 1, further comprising:
determining, by the second network node, at least one status report trigger; and
sending, by the second network node to the first network node, a status report indicating a status of the second network node in response to the at least one status report trigger.

14. The wireless communication method of claim 13, wherein the at least one status report trigger comprises at least one of Radio Frequency (RF) fault, overheating, or self-excitation.

15. The wireless communication method of claim 1, further comprising one of the following:
sending, by the second network node to the first network node based on a period, a status report indicating a status of the second network node, wherein the period is determined based on a configured status report period or a channel quality reporting period; or
sending, by the second network node to the first network node based on a configuration, a status report comprising acknowledgement to side control information from the first network node, wherein the configuration comprises at least one of a number of side control information messages and a periodic uplink grant used to carry the status report.

16. A wireless communication apparatus comprising at least one processor and a memory, wherein the at least one processor is configured to read code from the memory and implement a method recited in claim 1.

17. A non-transitory computer program product comprising a computer-readable program medium code stored thereupon, the computer-readable program medium code, when executed by at least one processor, causes the at least one processor to implement a method recited in claim 1.

18. A wireless communication method, comprising:
establishing a first communication link between a first network node and a second network node; and
communicating, by the first network node via the first communication link, with the second network node that communicates with a third network node via a second communication link.

19. A wireless communication apparatus comprising at least one processor and a memory, wherein the at least one processor is configured to read code from the memory and implement a method recited in claim 18.

20. A non-transitory computer program product comprising a computer-readable program medium code stored thereupon, the computer-readable program medium code, when executed by at least one processor, causes the at least one processor to implement a method recited in claim 18.
